(19) United States
(12) Patent Application Publication
(10) Pub. No.: US 2026/0051183 A1
(43) Pub. Date: Feb. 19, 2026

(54) CLASSIFICATION SYSTEM FOR A VEHICLE

(71) Applicant: GM Global Technology Operations LLC, Detroit, MI (US)

(72) Inventors: Mitesh Lalwala, Sterling Heights, MI (US); Siddhartha Gupta, Rochester Hills, MI (US)

(73) Assignee: GM Global Technology Operations LLC, Detroit, MI (US)

(21) Appl. No.: 18/809,128

(22) Filed: Aug. 19, 2024

(51) Int. Cl. G06V 20/59; G01S 13/89; G06V 10/80

(52) U.S. Cl. CPC G06V 20/59; G01S 13/89; G06V 10/80

(57) ABSTRACT

A computer-implemented method when executed by data processing hardware causes the data processing hardware to perform operations. The operations include capturing, by an imaging sensor, image data, the image data including an object, capturing, by a radar sensor, radar points corresponding to the object, and projecting, over the captured image data, the captured radar points. The operations also include estimating, by a classification algorithm, at least one of object key points and one or more object bounding boxes, classifying, based on one of the estimated at least one of object key points and one or more object bounding boxes, the object, and executing, in response to the classified object and a position of the object, a response function.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a classification system, and more specifically to a classification system for a vehicle.

Vehicles often have interior monitoring systems, such as camera systems. These camera systems are often used to monitor driving behavior or detect the presence of other occupants. Occupants occasionally sit in a passenger seat out of position, such that the position of the occupant may be unsafe or otherwise incompatible with the design of the seating position. While traditional camera systems may capture an improper position of the occupant, traditional vehicles are not typically equipped with the ability to assess the position of an occupant. Thus, there is a need for improved passenger monitoring within an interior of vehicles.

### SUMMARY

In some aspects, a computer-implemented method when executed by data processing hardware causes the data processing hardware to perform operations. The operations include capturing, by an imaging sensor, image data, the image data including an object, capturing, by a radar sensor, radar points corresponding to the object, and projecting, over the captured image data, the captured radar points. The operations also include estimating, by a classification algorithm, at least one of object key points and one or more object bounding boxes, classifying, based on one of the estimated at least one of object key points and one or more object bounding boxes, the object, and executing, in response to the classified object and a position of the object, a response function.

In some examples, the operations may include identifying the radar points in a proximity region of estimated object key points and estimating, based on the identified radar points, a three-dimensional (3D) location of the estimated object key points. The operations may also include determining, based on the 3D location, object segment lengths, and estimating an object classification based on the object segment lengths. In some instances, the operations may include identifying, by the classification algorithm, radar points overlapping with one or more estimated regions. The operations may also include generating, based on the identified radar points, 3D bounding boxes, and estimating dimensions of the 3D bounding boxes, the dimensions including a height, a width, and a depth of the 3D bounding boxes. Optionally, classifying, by the classification algorithm, may include classifying, based on the dimensions of the 3D bounding boxes, the object. In other examples, the response function may include at least one of adaptive restraints, airbag suppression, alerts, and notifications. In some instances, the operations may include generating a digital inventory of the image data.

In other aspects, a classification system for a vehicle includes data processing hardware and memory hardware in communication with the data processing hardware. The memory hardware stores instructions that when executed on the data processing hardware cause the data processing hardware to perform operations. The operations include capturing, by an imaging sensor, image data, the image data including an object, capturing, by a radar sensor, radar points corresponding to the object, and projecting, over the captured image data, the captured radar points. The operations also include estimating, by a classification algorithm, at least one of object key points and one or more object bounding boxes, classifying, based on one of the estimated at least one of object key points and one or more bounding boxes, the object, and executing, in response to the classified object and a position of the object, a response function.

In some examples, the operations may include identifying the radar points in a proximity region of estimated object key points and estimating, based on the identified radar points, a three-dimensional (3D) location of the estimated object key points. The operations may also include determining, based on the 3D location, object segment lengths, and estimating an object classification based on the object segment lengths. Optionally, the operations may include identifying, by the classification algorithm, radar points overlapping with one or more estimated regions. In some instances, the operations may include generating, based on the identified radar points, 3D bounding boxes, and estimating dimensions of the 3D bounding boxes, the dimensions including a height, a width, and a depth of the 3D bounding boxes. In some examples, classifying, by the classification algorithm, includes classifying, based on the dimensions of the 3D bounding boxes, the object. Optionally, the response function may include at least one of adaptive restraints, airbag suppression, alerts, and notifications. The operations may also include generating a digital inventory of the image data.

In yet another aspect, a computer-implemented method when executed by data processing hardware causes the data processing hardware to perform operations. The operations include capturing, by an imaging sensor, image data, the image data including an object, capturing, by a radar sensor, radar points corresponding to the object, and projecting, over the captured image data, the captured radar points. The operations also include estimating, by a classification algorithm, at least one of object key points and one or more object bounding boxes, classifying, based on one of the object key points and the one or more object bounding boxes, the object using a classification function of the classification algorithm, and executing, in response to the classified object and a position of the object, a response function, the response function including at least one of adaptive restraints and airbag suppression. The operations further include issuing, in response to the executed response function, an alert at a user interface of a vehicle and generating, by the classification algorithm, a digital inventory of the image data.

In some examples, the operations may include identifying the radar points in a proximity region of estimated object key points, estimating, based on the identified radar points, a three-dimensional (3D) location of the estimated object key points, determining, based on the 3D location, object segment lengths, and estimating an object classification based on the object segment lengths, and identifying, by the classification algorithm, radar points overlapping with one or more estimated regions. The operations may also include generating, based on the identified radar points, 3D bounding boxes, and estimating dimensions of the 3D bounding boxes, the dimensions including a height, a width, and a depth of the 3D bounding boxes. Optionally, the operations may include classifying, by the classification algorithm, includes classifying, based on the dimensions of the 3D bounding boxes, the object.

### BRIEF DESCRIPTION OF THE DRAWINGS

The drawings described herein are for illustrative purposes only of selected configurations and are not intended to limit the scope of the present disclosure.

FIG. 1 is a schematic of a vehicle equipped with a classification system according to the present disclosure;

FIG. 2 is an exemplary block diagram of a classification system according to the present disclosure;

FIG. 3 is a partial top perspective view of an interior cabin of a vehicle according to the present disclosure, the interior cabin including occupants;

FIG. 4 is another partial top perspective view of the interior cabin of FIG. 3 with one occupant out of position;

FIG. 5 is a schematic of a classification system according to the present disclosure executing a classification algorithm including radar points;

FIG. 6 is another schematic of a classification system according to the present disclosure executing a classification algorithm including bounding boxes;

FIG. 7 is a partial top perspective view of an interior cabin of a vehicle according to the present disclosure, the interior cabin including an object and an occupant;

FIG. 8 is a partial top perspective view of the interior cabin of FIG. 7 with the occupant exiting the vehicle and a classification system issuing a notification; and

FIG. 9 is an exemplary flow diagram of operations of a classification system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

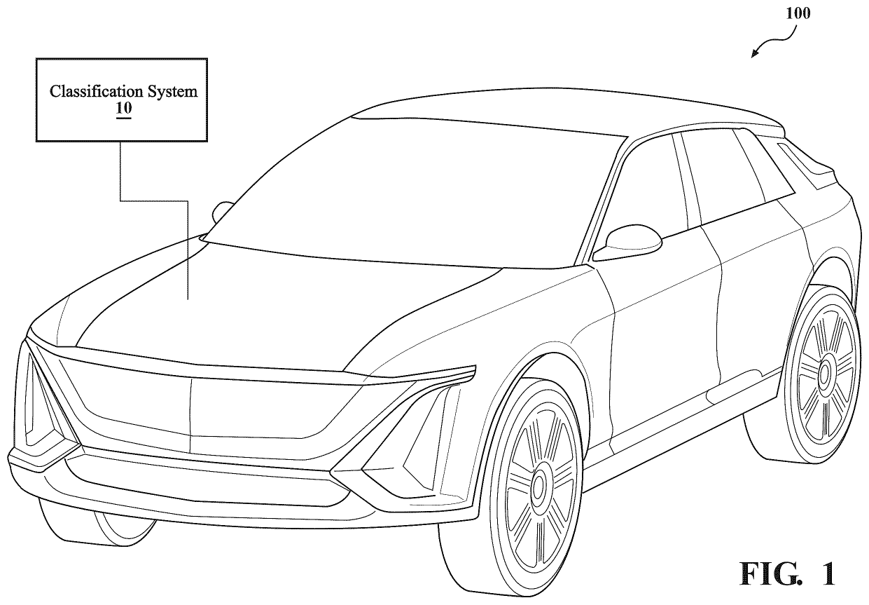

Referring to FIGS. 1-3, a vehicle 100 is equipped with a classification system 10. The classification system 10 is configured to monitor, in combination with a sensor system 200, an interior cabin 102 of the vehicle 100. In some instances, the classification system 10 may be configured as part of a cloud-based server 300 and is in communication with the sensor system 200 of the vehicle 100. For exemplary purposes, the classification system 10 is described with respect to being executed at the vehicle 100. However, the classification system 10 may be executed at the vehicle 100, the cloud-based server 300, or a combination of the vehicle 100 and the cloud-based server 300 without departing from the teachings herein. Regardless of the location of execution, the classification system 10 is configured to monitor and assess objects 400 within the interior cabin 102 of the vehicle in combination with the sensor system 200. The objects 400 described here may include, but are not limited to, occupants, boxes, animals, or any other practicable cargo that may be positioned within the interior cabin 102. Further, the objects 400 may be positioned anywhere within the interior cabin 102 of the vehicle 100, such that the object 400 may be positioned in any of the seating assemblies, a cargo area, a floor, or any other practicable location within the interior cabin 102.

The classification system 10 includes a controller 12 configured to execute a classification algorithm 14. For example, the controller 12 includes data processing hardware 16 that is configured to execute the classification algorithm 14. The controller 12 also includes memory hardware 18 in communication with the data processing hardware 16. The memory hardware stores instructions that, when executed on the data processing hardware 16, cause the data processing hardware 16 to perform operations, described herein. The controller 12 is communicatively coupled with the sensor system 200. For example, the sensor system 200 includes an imaging sensor 202 that is configured to capture image data 204 and a radar sensor 206 that is configured to capture radar points 208. The sensor system 200 may be positioned in any practicable location in the vehicle 100. For example, the sensor system 200 may be positioned in locations including, but not limited to, front, middle, back, and side pillars of the vehicle 100. It is further contemplated that the sensor system 200 may utilize a single sensor 202, 206 or may utilize any practicable number of sensors 202, 206 to capture the image data 204 and the radar points 208. The image data 204 and the radar points 208 are communicated with the controller 12 and utilized by the classification algorithm 14, described in more detail below.

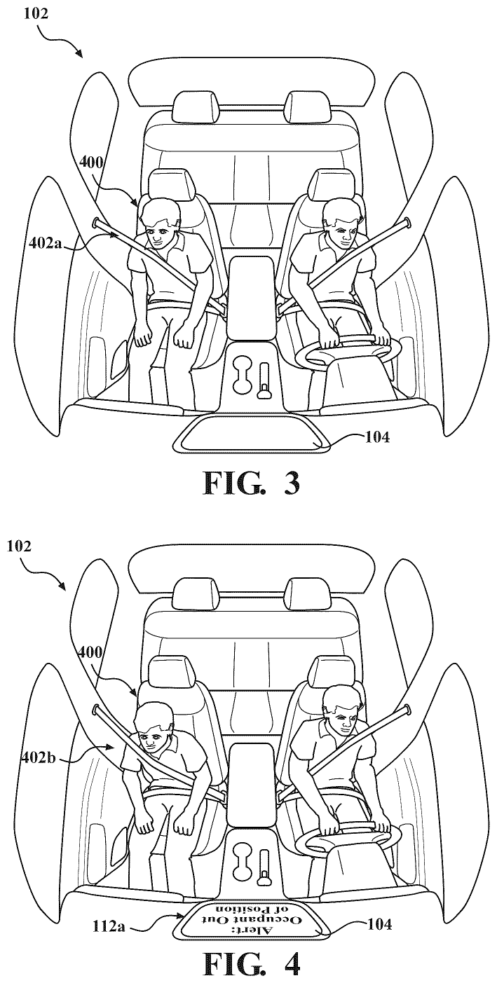

The image data 204 generally includes images of one or more objects 400 within the interior cabin 102. The classification system 10 may utilize the image data 204 to identify various object positions 402, which are utilized by the classification algorithm 14 to determine whether to execute a response function 20. For example, FIG. 3 illustrates an occupant 400 (e.g., object 400) in a first position 402a, and FIG. 4 illustrates the occupant 400 in a second position 402b. The classification algorithm 14 is configured to identify the object 400 in the second position 402b as being out of position relative to the first position 402b, described in more detail below. The imaging sensor 202 captures the image data 204, which includes the object 400, and communicates the image data 204 to the controller 12. Simultaneously, the radar sensor 206 captures the radar points 208 and communicates the radar points 208 to the controller 12. The classification algorithm 14 of the controller 12 receives both the image data 204 and the radar points 208 and utilizes each to determine the response function 20 associated with a safety system 110 of the vehicle 100.

The safety system 110 may execute various safety functions 112 in response to the response function 20 executed by the classification system 10. In some instances, the response function 20 may include the safety functions 112, such that the response function 20 and the safety functions 112 may include the same or similar functions. For example, the response function 20 and the safety functions 112 may include, but are not limited to, adaptive restraints, airbag suppression, alerts, and/or notifications. The response function 20 is determined by the classification algorithm 14 and, when executed, causes the controller 12 to communicate the response function 20 with the safety system 110. In response to the received response function 20, the safety system 110 executes the respective safety function 112. In one example, an alert 112a may be issued on a user interface 104 of the vehicle 100.

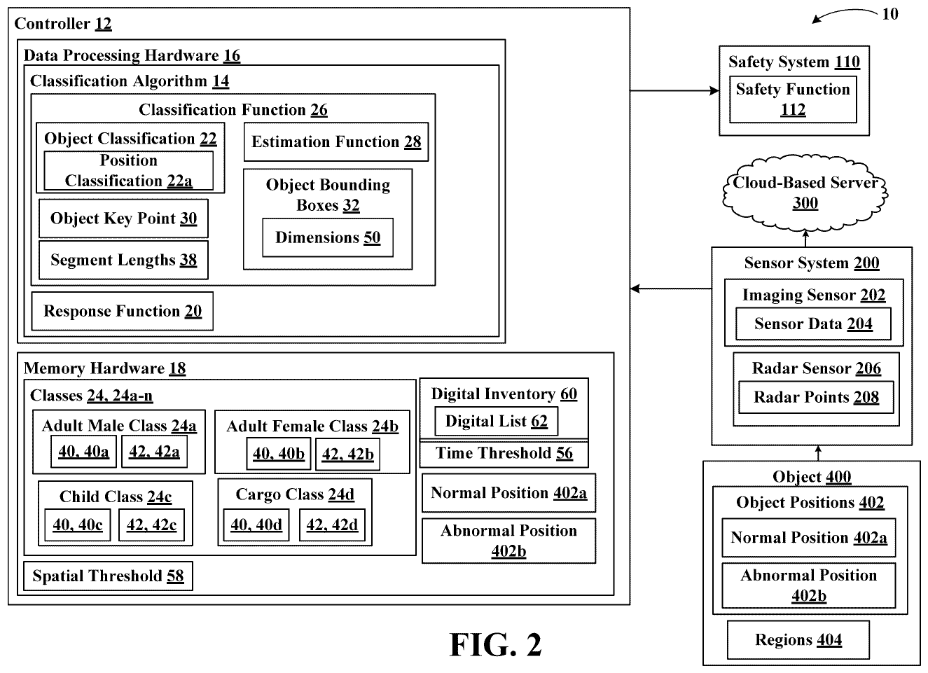

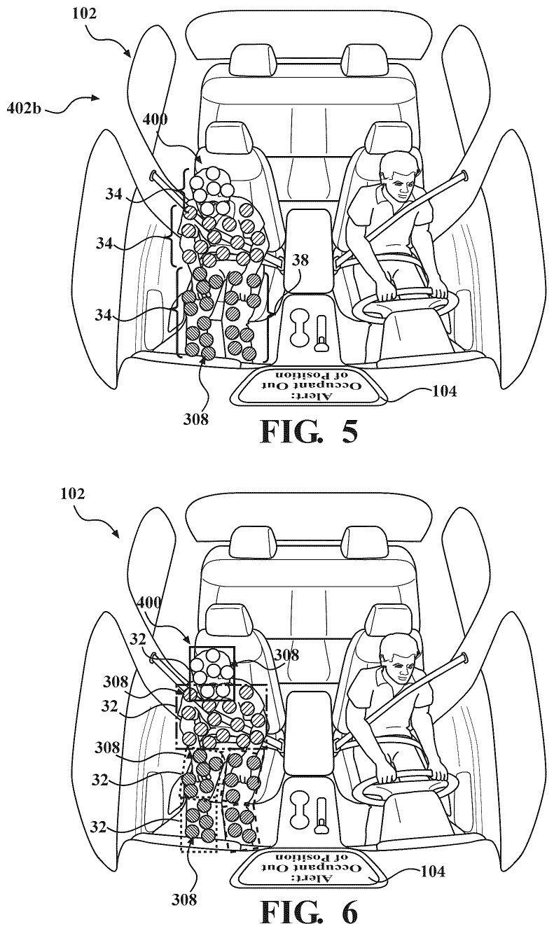

Referring now to FIGS. 2-6, the classification algorithm 14 is configured to determine an object classification 22 based on the image data 204 and the radar points 208 received from the sensor system 200. The object classification 22 includes classes 24, 24a-n, which are used to categorize or classify the objects 400. The classes 24, 24a-n may be stored in the memory hardware 18 for selective use by the classification algorithm 14. As mentioned above, the objects 400 may include children, adults, cargo, animals, etc. Each object 400 may undergo object classification 22 to be classified into a respective class 24. The classes 24, 24a-n may include, but are not limited to, an adult male class 24a, an adult female class 24b, a child class 24c, and a cargo class 24d. Each class 24, 24a-n may correspond with specialized safety functions 112 associated with each class. For example, the classification algorithm 14 may determine that the object 400 is classified as a child class 24c and may execute the response function 20 corresponding to airbag suppression safety functions 112. In other examples, the response function 20 may correspond to a notification safety function 112 reminding a driver to take the child upon exiting the vehicle 100. The safety functions 112 may be cross-referenced for different classes 24, 24a-n, such that the safety functions 112 may overlap between classes 24, 24a-n and are not limited to a particular class 24, 24a-n.

The classification algorithm 14 may be activated by the controller 12 in response to receiving the image data 204 and the radar points 208. The classification algorithm 14 is configured to project the radar points 208 over the image data 204. For example, the radar points 208 are three-dimensional (3D) points of the object 400 that are captured by the radar sensor 206, which contain spatial information about the captured radar points 208 in 3D space. The image data 204 is a two-dimensional (2D) representation of the object 400. The radar points 208 are projected from the 3D space into the 2D image space of the image sensor 202. Once the radar points 208 are projected onto the image data 204, the classification 14 may execute a classification function 26. The classification function 26 is utilized to estimate, via an estimation function 28, at least one of object key points 30 and one or more bounding boxes 32, described in more detail below.

With specific reference to FIGS. 2-5, the classification function 26 of the classification algorithm 14 is illustrated with the projected radar points 208 overlaid with the image data 204. The estimation function 28 analyzes the image data 204 to estimate the object key points 30, which may correspond to various regions 404 of the object 400. For example, the classification function 26 may identify the object 400 as an occupant and identify key body points 30 (i.e., head point, shoulder points, elbow points, hip points, knee points, ankle points, etc.), which may correspond with various regions 404 (i.e., head, shoulders, elbows, hips, knees, ankles, etc.) of the object 400. In executing the estimation function 28, the classification function 26 identifies the radar points 208 in a proximity of the estimated object key points 30. The identified radar points 208 may be a single point or multiple points that are closest to the key body point 30 in the image data 204. The classification function 26 utilizes the identified radar points 208 to estimate the 3D position of the key body point 30 of the object 400.

For example, the classification function 26 may execute the estimation function 28 to estimate, based on the identified radar points 208 and key body point 30, a 3D location of the estimated object key points 30. The classification function 26 of the classification algorithm 14 may utilize the location of the object key points 30 to determine object segment lengths 38 using the estimated 3D positions of the identified key points 30. The object segment lengths 38 may generally correspond to lengths of the various regions 404 of the object. In an example of an occupant 400, the classification algorithm 14 may determine a segment length 38 including, but not limited to, shoulder width, torso height, torso width, hip width, limb lengths, and torso to head height of the occupant 400 using the 3D positions of the identified key body points 30.

The classification algorithm 14 may utilize the determined segment lengths 38 to execute the object classification 22 and classify the object 400. For example, each class 24, 24a-n may store estimated regions 40, 40a-n and estimated segment ranges 42, 42a-n, which may be used by the classification function 26 when estimating the object classification 22. The segment lengths 38 determined by the classification algorithm 14 may be compared with the estimated segment ranges 42, 42a-n of each class 24, 24a-n to classify the object 400 (i.e., child, adult male, adult female, etc.). Once the object 400 is classified, the classification algorithm 14 may execute the response function 20 to trigger one or more safety functions 112.

With specific reference to FIGS. 2-4 and 6, the classification function 26 of the classification algorithm 14 is illustrated with the projected radar points 208 overlaid with the image data 204 with the regions 404 identified by bounding boxes 32, described below. As mentioned above, the classification function 26 may identify various regions 404 of the object 400 from the image data 204, and the radar points 208 are overlain with the image data 204. The classification algorithm 14 evaluates the radar points 208 enclosed within an estimated region 404 relative to the image data 204. Using the spatial information from the radar points 208, the classification function 26 may construct 3D bounding boxes 32 for each of the regions 404.

The estimation function 28 may also estimate dimensions 50 of the 3D bounding boxes 32. The dimensions 50 may include a height, a width, and a depth of the 3D bounding boxes 32. For example, the radar points 208 may be utilized by the classification algorithm 14 to identify the dimensions 50 of the bounding boxes 32. The dimensions 50 of the bounding boxes 32 are utilized during object classification 32 of the classification function 26, described below.

The dimensions 50 of the bounding boxes 32 may also be utilized by the classification algorithm 14 to determine the segment length 38 of the object 400. As mentioned above, the determined segment length 38 may be compared with the stored estimated segment ranges 42, 42a-n for each of the estimated regions 40, 40a-n. Based on the comparison of the dimensions 50 of the bounding boxes 32 with the estimated segment lengths 42, 42a-n, the classification algorithm 14 may classify the object 400. Once the object 400 is classified into an object classification 22, the classification algorithm 14 may execute the response function 20, and the safety system 110 may execute one or more safety features 112 corresponding to the response function 20 and the respective class 24, 24a-n.

The classification system 10 may also be utilized to determine whether the object 400 is out of position, as mentioned above. Based on the 3D spatial positions of different regions 404 of the object 400, the object 400 may be detected in the first, normal position 402a and later detected in the second, abnormal position 402b. For example, the abnormal position 402b may correspond with the object 400 being out of position or out of the normal position 402a. Examples of the abnormal position 402b include, but are not limited to, the object 400 being at least partially positioned outside of the vehicle 100 and legs of an occupant 400 on a dashboard of the vehicle 100. The classification system 10 may utilize the object positions 400 in addition to the object classification 22, described above, to evaluate the object 400. For example, the classification system 10 may store the normal position 402a and the abnormal position 402b in the memory hardware 18 for reference when determining the object position 402.

The classification system 10 may monitor the duration of time in which the object 400 is in the second position 402b to determine whether the object 400 is being temporarily repositioned or if the object 400 is out of position in the second position 402b. For example, a time threshold 56 may be stored on the memory hardware 18. The classification algorithm 14 may determine, based on the image data 204 and/or the radar points 208, that the object 400 is in the second position 402b. For example, the classification system 10 may include a spatial threshold 58 that is utilized by the classification algorithm 14 to identify a position classification 22a of the object 400, which includes the object position 402 (i.e., normal vs. abnormal positions 402a, 402b). If the object 400 remains in the second position 402b for a period of time exceeding the time threshold 56, then the classification system 10 may issue a response function 20 to trigger a safety function 112.

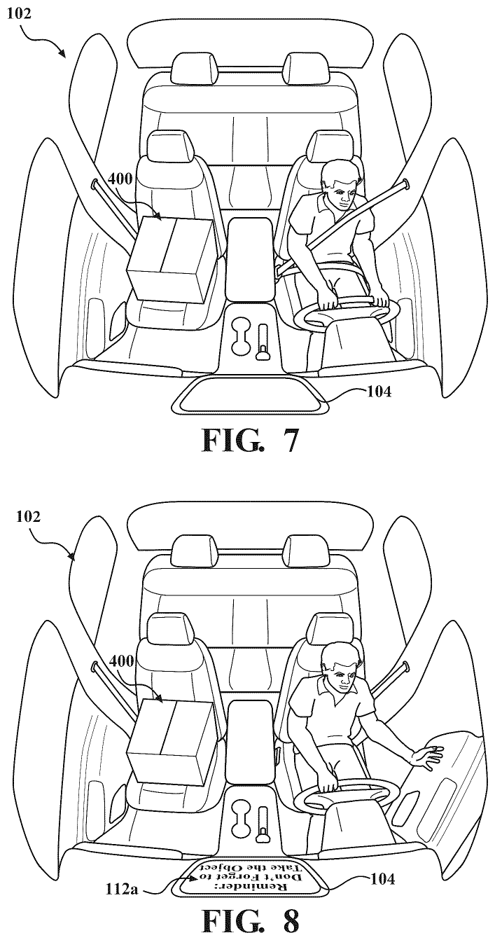

With specific reference to FIGS. 2, 7, and 8, the classification algorithm 14 may be utilized to detect, identify, and classify inanimate objects 400, such as cargo, in addition to occupant objects 400, generally described above. For example, FIGS. 7 and 8 illustrate an object 400 in a passenger seat 106 of the vehicle 100. The classification algorithm 14 may execute either of the processes described above (i.e., using the object key points 30 and/or the object bounding boxes 32) to classify the object 400 and execute the response function 20 based on the class 24, 24d of the object 400. The illustrated example, at FIG. 8, depicts a driver exiting the vehicle 100 and receiving an alert 112a on the user interface 104 corresponding to the object 400. The alert 112a is triggered by the classification algorithm 14 classifying the object 400 into the cargo class 24d, and the response function 20 triggering the alert 112a of the safety functions 112. For example, the alert 112a may remind the driver not to leave the object 400 in the vehicle 100.

Referring again to FIGS. 2-8, the classification algorithm 14 may also be configured to generate a digital inventory 60 of the objects 400 within the vehicle 100. The digital inventory 60 may be stored on the memory hardware 18 and may contain a digital list 62 of the identified objects 400 and the corresponding object classifications 22 and location of the object 400. In some instances, the controller 12 may reference the digital inventory 60 when executing the classification algorithm 14 to determine if any of the objects 400 captured in the image data 204 are reflected in the digital inventory 60. If an object 400 is listed on the digital list 62, then the classification algorithm 14 may pull the corresponding object classification 22. Thus, the classification algorithm 14 may determine the class 24, 24a-n of the object 400 by referencing the digital inventory 60. Further, the digital inventory 60 may be accessed by a user to monitor the object 400 that may remain in the vehicle 100 once the user exits the vehicle 100.

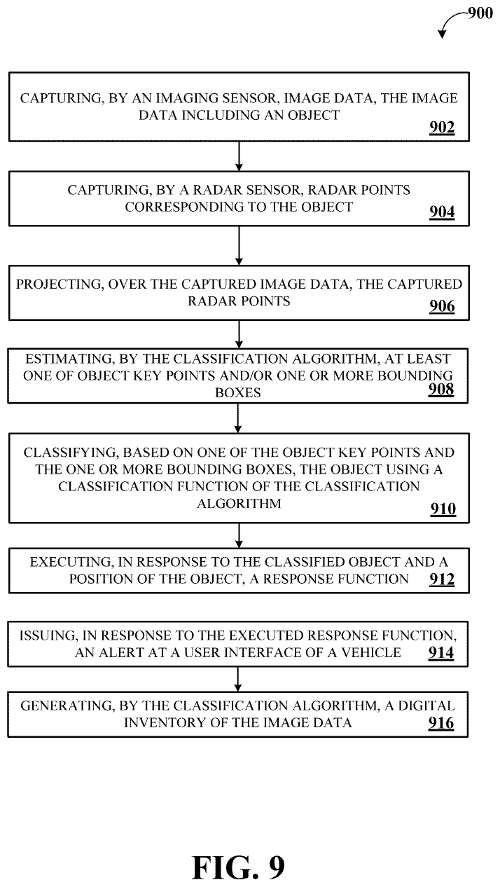

Referring to FIGS. 1-9, an exemplary flow diagram 900 of the classification system 10 is depicted in FIG. 9. At 902, the classification system 10 captures, by an imaging sensor 202, image data 204. The image data 204 includes an object 400. The classification system 10, at 904, captures, by a radar sensor 206, radar points 208 corresponding to the object 400. At 906, the classification system 10 projects, over the captured image data 204, the captured radar points 208. At 908, the classification algorithm 14 estimates at least one of object key points 30 and/or one or more object bounding boxes 32. The classification system 10, at 910, classifies the object 400 using a classification function 26 of the classification algorithm 14 based on one of the object key points 30 and the one or more object bounding boxes 32. At 912, the classification system 10 executes, in response to the classified object 400, a response function 20. The response function 20 includes at least one of adaptive restraints and airbag suppression. At 914, the classification system 10 issues, in response to the executed response function 20, an alert 112a at a user interface 104 of a vehicle 100. The classification algorithm 14, at 916, generates a digital inventory 60 of the objects 400.

With reference again to FIGS. 1-9, the classification system 10 advantageously classifies the objects 400 into the object classification 22, which can be used to execute various safety functions 112 of a safety system 110. The safety functions 112 may be customized based on the object classification 22 to fit the object 400. For example, if the object 400 is a child, then the classification system 10 may execute a response function 20 corresponding to a child class 24, 24c, which may trigger safety functions 112 that are tailored to the child class 24, 24c (i.e., adapted restraints, airbag suppression, etc.). Further, the classification system 10 may present an occupant with alerts and notifications (i.e., safety functions 112) that reminds the occupant to remove the object 400 (i.e., cargo, a child, etc.) from the vehicle 100 upon exiting. The classification system 10 may advantageously utilize two separate methods of identifying and classifying the objects 400 (i.e., the object key points 30 or the bounding boxes 32). Each of the methods may ultimately be utilized to classify the objects 400 and determine the position 402 of the object 400 within the vehicle 100, as set forth herein.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A computer-implemented method when executed by data processing hardware causes the data processing hardware to perform operations comprising:
capturing, by an imaging sensor, image data, the image data including an object;
capturing, by a radar sensor, radar points corresponding to the object;
projecting, over the captured image data, the captured radar points;
estimating, by a classification algorithm, at least one of object key points and one or more object bounding boxes;
classifying, based on one of the estimated at least one of object key points and one or more object bounding boxes, the object; and
executing, in response to the classified object and a position of the object, a response function.

2. The method of claim 1, further including identifying the radar points in a proximity region of estimated object key points and estimating, based on the identified radar points, a three-dimensional (3D) location of the estimated object key points.

3. The method of claim 2, further including determining, based on the 3D location, object segment lengths, and estimating an object classification based on the object segment lengths.

4. The method of claim 1, further including identifying, by the classification algorithm, radar points overlapping with one or more estimated regions.

5. The method of claim 4, further including generating, based on the identified radar points, 3D bounding boxes, and estimating dimensions of the 3D bounding boxes, the dimensions including a height, a width, and a depth of the 3D bounding boxes.

6. The method of claim 5, wherein classifying, by the classification algorithm, includes classifying, based on the dimensions of the 3D bounding boxes, the object.

7. The method of claim 1, wherein the response function includes at least one of adaptive restraints, airbag suppression, alerts, and notifications.

8. The method of claim 1, further including generating a digital inventory of the image data.

9. A classification system for a vehicle, the classification system comprising:
data processing hardware; and
memory hardware in communication with the data processing hardware, the memory hardware storing instructions that when executed on the data processing hardware cause the data processing hardware to perform operations comprising:
capturing, by an imaging sensor, image data, the image data including an object;
capturing, by a radar sensor, radar points corresponding to the object;
projecting, over the captured image data, the captured radar points;
estimating, by a classification algorithm, at least one of object key points and one or more object bounding boxes;
classifying, based on one of the estimated at least one of object key points and one or more bounding boxes, the object; and
executing, in response to the classified object and a position of the object, a response function.

10. The classification system of claim 9, further including identifying the radar points in a proximity region of estimated object key points and estimating, based on the identified radar points, a three-dimensional (3D) location of the estimated object key points.

11. The classification system of claim 10, further including determining, based on the 3D location, object segment lengths, and estimating an object classification based on the object segment lengths.

12. The classification system of claim 9, further including identifying, by the classification algorithm, radar points overlapping with one or more estimated regions.

13. The classification system of claim 12, further including generating, based on the identified radar points, 3D bounding boxes, and estimating dimensions of the 3D bounding boxes, the dimensions including a height, a width, and a depth of the 3D bounding boxes.

14. The classification system of claim 13, wherein classifying, by the classification algorithm, includes classifying, based on the dimensions of the 3D bounding boxes, the object.

15. The classification system of claim 9, wherein the response function includes at least one of adaptive restraints, airbag suppression, alerts, and notifications.

16. The classification system of claim 9, further including generating a digital inventory of the image data.

17. A computer-implemented method when executed by data processing hardware causes the data processing hardware to perform operations comprising:
capturing, by an imaging sensor, image data, the image data including an object;
capturing, by a radar sensor, radar points corresponding to the object;
projecting, over the captured image data, the captured radar points;
estimating, by a classification algorithm, at least one of object key points and one or more object bounding boxes;
classifying, based on one of the object key points and the one or more object bounding boxes, the object using a classification function of the classification algorithm;
executing, in response to the classified object and a position of the object, a response function, the response function including at least one of adaptive restraints and airbag suppression;
issuing, in response to the executed response function, an alert at a user interface of a vehicle; and
generating, by the classification algorithm, a digital inventory of the image data.

18. The method of claim 17, further including:
identifying the radar points in a proximity region of estimated object key points;
estimating, based on the identified radar points, a three-dimensional (3D) location of the estimated object key points;
determining, based on the 3D location, object segment lengths, and estimating an object classification based on the object segment lengths; and
identifying, by the classification algorithm, radar points overlapping with one or more estimated regions.

19. The method of claim 18, further including generating, based on the identified radar points, 3D bounding boxes, and estimating dimensions of the 3D bounding boxes, the dimensions including a height, a width, and a depth of the 3D bounding boxes.

20. The method of claim 19, wherein classifying, by the classification algorithm, includes classifying, based on the dimensions of the 3D bounding boxes, the object.
